(19) United States
(12) Patent Application Publication
(10) Pub. No.: US 2018/0025076 A1
(43) Pub. Date: Jan. 25, 2018

(54) Collaborative Question Interceptor

(71) Applicant: International Business Machines Corporation, Armonk, NY (US)

(72) Inventors: Paul R. Bastide, Boxford, MA (US); Lisa Seacat DeLuca, Baltimore, MD (US); Dana L. Price, Surf City, NC (US); Shelbee D. Smith-Eigenbrode, Thornton, CO (US)

(21) Appl. No.: 15/214,735

(22) Filed: Jul. 20, 2016

(51) Int. Cl. G06F 17/30; G06F 3/0484; H04L 12/58

(52) U.S. Cl. CPC G06F 17/30684; H04L 51/16; H04L 51/32; H04L 51/38; H04L 51/36; G06F 17/30654; G06F 3/04842

(57) ABSTRACT

Question interception is provided. It is determined that a first user corresponding to a data processing system is composing a message to be transmitted to a second data processing system corresponding to a second user. It is determined whether a question for the second user is identified in the message prior to transmitting the message to the second data processing system. In response to determining that a question is identified in the message, an answer to the question is retrieved from a plurality of data sources. A confidence score is calculated for the answer. It is determined whether the confidence score is greater than or equal to a confidence level threshold value. In response to determining that the confidence score is greater than or equal to the confidence level threshold value, the answer is displayed to the first user prior to transmitting the message to the second data processing system.

### BACKGROUND

### 1. Field

The disclosure relates generally to electronic messages and more specifically to intercepting a question included in an electronic message prior to transmission of the electronic message to a target recipient.

### 2. Description of the Related Art

It is common for people to ask friends and family for answers to questions regarding topics that they know the person being asked the question has an answer. For example, Bob may always call his father when he gets a flat tire or when he needs to change motor oil because Bob's father was an auto mechanic and is very good when it comes to cars. However, Bob's father may become annoyed when Bob asks him easy questions that Bob could easily find out the answer to. Today, Bob's father may just tell his son to search the World Wide Web for the answer to his question.

### SUMMARY

According to one illustrative embodiment, a computer-implemented method for question interception is provided. A data processing system determines that a first user corresponding to the data processing system is composing an electronic message to be transmitted via a network to a second data processing system corresponding to a second user. The data processing system determines whether a question for the second user is identified in the electronic message prior to transmitting the electronic message to the second data processing system. In response to the data processing system determining that a question for the second user is identified in the electronic message prior to transmitting the electronic message to the second data processing system, the data processing system retrieves an answer to the question from at least one of a plurality of data sources. The data processing system calculates a confidence score for the answer to the question. The data processing system determines whether the confidence score for the answer to the question is greater than or equal to a defined confidence level threshold value. In response to the data processing system determining that the confidence score for the answer to the question is greater than or equal to the defined confidence level threshold value, the data processing system displays the answer to the question to the first user prior to transmitting the electronic message to the second data processing system. According to other illustrative embodiments, a data processing system and computer program product for question interception are provided.

### BRIEF DESCRIPTION OF THE DRAWINGS

FIG. 1 is a pictorial representation of a network of data processing systems in which illustrative embodiments may be implemented;

FIG. 2 is a diagram of a data processing system in which illustrative embodiments may be implemented;

FIG. 3 is a diagram illustrating an example of a social networking service message in accordance with an illustrative embodiment;

FIG. 4 is a diagram illustrating an example of a short message service message in accordance with an illustrative embodiment;

FIG. 5 is a flowchart illustrating a process for displaying an answer to a question included in an electronic message prior to transmitting the electronic message in accordance with an illustrative embodiment; and

FIGS. 6A-6B are a flowchart illustrating a process for intercepting a question included in an electronic message prior to transmitting the electronic message in accordance with an illustrative embodiment.

### DETAILED DESCRIPTION

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer readable program instructions.

These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

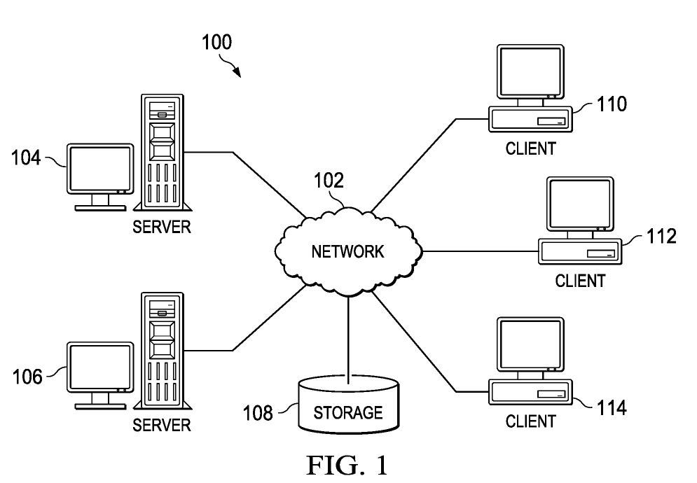

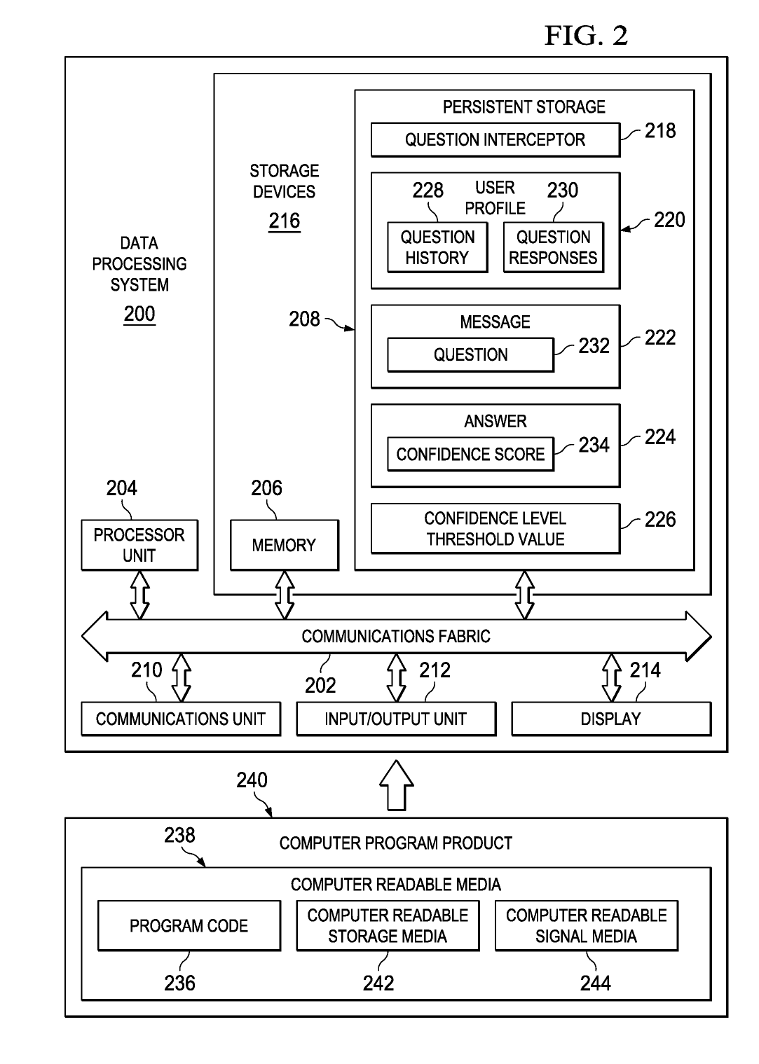

With reference now to the figures, and in particular, with reference to FIGS. 1-2, diagrams of data processing environments are provided in which illustrative embodiments may be implemented. It should be appreciated that FIGS. 1-2 are only meant as examples and are not intended to assert or imply any limitation with regard to the environments in which different embodiments may be implemented. Many modifications to the depicted environments may be made.

FIG. 1 depicts a pictorial representation of a network of data processing systems in which illustrative embodiments may be implemented. Network data processing system 100 is a network of computers, data processing systems, and other devices in which the illustrative embodiments may be implemented. Network data processing system 100 contains network 102, which is the medium used to provide communications links between the computers, data processing systems, and other devices connected together within network data processing system 100. Network 102 may include connections, such as, for example, wire communication links, wireless communication links, and fiber optic cables.

In the depicted example, server 104 and server 106 connect to network 102, along with storage 108. Server 104 and server 106 may be, for example, server computers with high-speed connections to network 102. In addition, server 104 and server 106 may provide services to users of client devices. For example, server 104 and server 106 may host one or more electronic messaging services to registered clients. An electronic message may be, for example, an email, a short message service (SMS) text message, a direct electronic message, a social media textual message, a social networking service message, an instant text message, and the like.

In addition, server 104 and/or server 106 may provide other services, such as, for example, a service that intercepts questions contained within electronic messages sent from a user of a sending client device to a user on a receiving client device prior to forwarding an electronic message from a sending client device to a receiving client device. The question interception service attempts to answer the question contained in the electronic message by searching multiple data sources for the answer and then sending the answer to the user of the sending client device prior to forwarding the electronic message to the receiving client device.

Client 110, client 112, and client 114 also connect to network 102. Clients 110, 112, and 114 are registered clients of server 104 and server 106. For example, a user of client 110 may utilize the electronic messaging service provided by server 104 to send an electronic message to a user of client 112. Further, server 104 and server 106 may provide information, such as boot files, operating system images, and software applications to clients 110, 112, and 114.

In this example, clients 110, 112, and 114 are illustrated as desktop computers, which may have wire or wireless communication links to network 102. However, it should be noted that clients 110, 112, and 114 are intended as examples only. In other words, clients 110, 112, and 114 also may include other devices, such as, for example, laptop computers, handheld computers, smart phones, smart watches, personal digital assistants, gaming devices, set-top boxes, or any combination thereof.

Storage 108 is a network storage device capable of storing any type of data in a structured format or an unstructured format. In addition, storage 108 may represent a set of one or more network storage devices. Storage 108 may store, for example, names and identification numbers for a plurality of different users, profiles corresponding to the different users, question histories, question responses, and the like. Further, storage 108 may store other data, such as authentication or credential data that may include user names, passwords, and biometric data associated with the plurality of different users and system administrators, for example.

In addition, it should be noted that network data processing system 100 may include any number of additional server devices, client devices, and other devices not shown. Program code located in network data processing system 100 may be stored on a computer readable storage medium and downloaded to a computer or other data processing device for use. For example, program code may be stored on a computer readable storage medium on server 104 and downloaded to client 110 over network 102 for use on client 110.

In the depicted example, network data processing system 100 may be implemented as a number of different types of communication networks, such as, for example, an internet, an intranet, a local area network (LAN), and a wide area network (WAN). FIG. 1 is intended as an example, and not as an architectural limitation for the different illustrative embodiments.

With reference now to FIG. 2, a diagram of a data processing system is depicted in accordance with an illustrative embodiment. Data processing system 200 is an example of a data processing system, such as client 110 in FIG. 1, in which computer readable program code or program instructions implementing processes of illustrative embodiments may be located. In this illustrative example, data processing system 200 includes communications fabric 202, which provides communications between processor unit 204, memory 206, persistent storage 208, communications unit 210, input/output (I/O) unit 212, and display 214.

Processor unit 204 serves to execute instructions for software applications and programs that may be loaded into memory 206. Processor unit 204 may be a set of one or more hardware processor devices or may be a multi-processor core, depending on the particular implementation. Further, processor unit 204 may be implemented using one or more heterogeneous processor systems, in which a main processor is present with secondary processors on a single chip. As another illustrative example, processor unit 204 may be a symmetric multi-processor system containing multiple processors of the same type.

Memory 206 and persistent storage 208 are examples of storage devices 216. A computer readable storage device is any piece of hardware that is capable of storing information, such as, for example, without limitation, data, computer readable program code in functional form, and/or other suitable information either on a transient basis and/or a persistent basis. Further, a computer readable storage device excludes a propagation medium. Memory 206, in these examples, may be, for example, a random access memory, or any other suitable volatile or non-volatile storage device. Persistent storage 208 may take various forms, depending on the particular implementation. For example, persistent storage 208 may contain one or more devices. For example, persistent storage 208 may be a hard drive, a flash memory, a rewritable optical disk, a rewritable magnetic tape, or some combination of the above. The media used by persistent storage 208 may be removable. For example, a removable hard drive may be used for persistent storage 208.

In this example, persistent storage 208 stores question interceptor 218. Question interceptor 218 monitors and controls the interception of questions included within electronic messages to be sent from a user of data processing system 200 (i.e., the sending device) to another user on a receiving data processing device prior to transmission of the electronic message to the receiving data processing device user. It should be noted that even though question interceptor 218 is illustrated as residing in persistent storage 208, in an alternative illustrative embodiment question interceptor 218 may be a separate component of data processing system 200. For example, question interceptor 218 may be a hardware component coupled to communication fabric 202 or a combination of hardware and software components.

In this example, persistent storage 208 also stores user profile 220, message 222, answer 224, and confidence level threshold value 226. User profile 220 includes information regarding the user of data processing system 200. For example, user profile 220 may include name, nicknames, home address, work address, employer, job title, job duties, roles, coworkers, friends, family, hobbies, major items owned, memberships, and the like. In addition, user profile 220 may include question history 228 and question responses 230. Question history 228 represents a history or summary of the different types of questions asked by the user in electronic messages to others. Question responses 230 represent a list or summary of the different types of answers received from others in response to questions sent by the user.

Message 222 represents a particular electronic message composed by the user of data processing system 200 that is to be sent to a user of another data processing system via a network, such as network 102 in FIG. 1. The electronic message may be, for example, an email, an SMS text message, a direct electronic message, a social media textual message, a social networking service message, an instant text message, or the like. In this example, message 222 includes question 232. Question 232 is asking the user of the other data processing system for an answer to a specific question, such as “How do I research patent applications at the United States Patent and Trademark Office?”

In response to question interceptor 218 determining that question 232 exists in message 222, question interceptor 218 searches multiple data sources to find an answer, such as answer 224, to question 232 prior to data processing system 200 transmitting message 222 to the other data processing system. The multiple data sources may be, for example, question history 228, question responses 230, other data stored in user profile 220, persistent storage 208, and memory 206, online search engine results, video search results, data processing system personal assistant software search results, databases corresponding to an enterprise employing the user, social media databases and accounts corresponding to the user, previous social networking service messages, social media discussions regarding a particular question, and the like. Answer 224 represents a set of one or more answers to question 232 found by question interceptor 218 during the search.

Afterward, question interceptor 218 calculates confidence score 234 for answer 224. Confidence score 234 may be, for example, a percentage of relevance answer 224 is to question 232. Further, question interceptor 218 compares confidence score 234 with confidence level threshold value 226. Confidence level threshold value 226 represents a predefined threshold that confidence score 234 should be equal to or greater than. If question interceptor 218 determines that confidence score 234 for answer 224 is less than confidence level threshold value 226 or if question interceptor 218 does not find an answer to question 232, then question interceptor 218 directs data processing system 200 to transmit message 222 to the other data processing system. If, on the other hand, question interceptor 218 determines that confidence score 234 for answer 224 is equal to or greater than confidence level threshold value 226, then question interceptor 218 directs data processing system 200 to display answer 224 over or adjacent to question 232 in display 214. Question interceptor 218 then waits to receive an input from the user to either cancel transmission of message 222 or continue with transmission of message 222 to the other data processing system.

Communications unit 210, in this example, provides for communication with other computers, data processing systems, and devices via a network, such as network 102 in FIG. 1. Communications unit 210 may provide communications using both physical and wireless communications links. The physical communications link may utilize, for example, a wire, cable, universal serial bus, or any other physical technology to establish a physical communications link for data processing system 200. The wireless communications link may utilize, for example, shortwave, high frequency, ultra high frequency, microwave, wireless fidelity (Wi-Fi), bluetooth technology, global system for mobile communications (GSM), code division multiple access (CDMA), second-generation (2G), third-generation (3G), fourth-generation (4G), 4G Long Term Evolution (LTE), LTE Advanced, or any other wireless communication technology or standard to establish a wireless communications link for data processing system 200.

Input/output unit 212 allows for the input and output of data with other devices that may be connected to data processing system 200. For example, input/output unit 212 may provide a connection for user input through a keypad, a keyboard, a mouse, and/or some other suitable input device. The user may utilize an input device to compose message 222. Display 214 provides a mechanism to display information, such as, for example, message 222 and answer 224, to the user and may include touch screen capabilities to allow the user to make on-screen selections through user interfaces or input data, for example.

Instructions for the operating system, applications, and/or programs may be located in storage devices 216, which are in communication with processor unit 204 through communications fabric 202. In this illustrative example, the instructions are in a functional form on persistent storage 208. These instructions may be loaded into memory 206 for running by processor unit 204. The processes of the different embodiments may be performed by processor unit 204 using computer implemented program instructions, which may be located in a memory, such as memory 206. These program instructions are referred to as program code, computer usable program code, or computer readable program code that may be read and run by a processor in processor unit 204. The program code, in the different embodiments, may be embodied on different physical computer readable storage devices, such as memory 206 or persistent storage 208.

Program code 236 is located in a functional form on computer readable media 238 that is selectively removable and may be loaded onto or transferred to data processing system 200 for running by processor unit 204. Program code 236 and computer readable media 238 form computer program product 240. In one example, computer readable media 238 may be computer readable storage media 242 or computer readable signal media 244. Computer readable storage media 242 may include, for example, an optical or magnetic disc that is inserted or placed into a drive or other device that is part of persistent storage 208 for transfer onto a storage device, such as a hard drive, that is part of persistent storage 208. Computer readable storage media 242 also may take the form of a persistent storage, such as a hard drive, a thumb drive, or a flash memory that is connected to data processing system 200. In some instances, computer readable storage media 242 may not be removable from data processing system 200.

Alternatively, program code 236 may be transferred to data processing system 200 using computer readable signal media 244. Computer readable signal media 244 may be, for example, a propagated data signal containing program code 236. For example, computer readable signal media 244 may be an electro-magnetic signal, an optical signal, and/or any other suitable type of signal. These signals may be transmitted over communication links, such as wireless communication links, an optical fiber cable, a coaxial cable, a wire, and/or any other suitable type of communications link. In other words, the communications link and/or the connection may be physical or wireless in the illustrative examples. The computer readable media also may take the form of non-tangible media, such as communication links or wireless transmissions containing the program code.

In some illustrative embodiments, program code 236 may be downloaded over a network to persistent storage 208 from another device or data processing system through computer readable signal media 244 for use within data processing system 200. For instance, program code stored in a computer readable storage media in a data processing system may be downloaded over a network from the data processing system to data processing system 200. The data processing system providing program code 236 may be a server computer, a client computer, or some other device capable of storing and transmitting program code 236.

The different components illustrated for data processing system 200 are not meant to provide architectural limitations to the manner in which different embodiments may be implemented. The different illustrative embodiments may be implemented in a data processing system including components in addition to, or in place of, those illustrated for data processing system 200. Other components shown in FIG. 2 can be varied from the illustrative examples shown. The different embodiments may be implemented using any hardware device or system capable of executing program code. As one example, data processing system 200 may include organic components integrated with inorganic components and/or may be comprised entirely of organic components excluding a human being. For example, a storage device may be comprised of an organic semiconductor.

As another example, a computer readable storage device in data processing system 200 is any hardware apparatus that may store data. Memory 206, persistent storage 208, and computer readable storage media 242 are examples of physical storage devices in a tangible form.

In another example, a bus system may be used to implement communications fabric 202 and may be comprised of one or more buses, such as a system bus or an input/output bus. Of course, the bus system may be implemented using any suitable type of architecture that provides for a transfer of data between different components or devices attached to the bus system. Additionally, a communications unit may include one or more devices used to transmit and receive data, such as a modem or a network adapter. Further, a memory may be, for example, memory 206 or a cache such as found in an interface and memory controller hub that may be present in communications fabric 202.

In the course of developing illustrative embodiments, it was discovered that no mechanism currently exists to stop a user of a data processing device from sending an electronic message that includes a question when an answer to the question could possibly be found during a search of information sources. One current technology allows a recipient to send a uniform resource locator (URL) with a link to a webpage where the sender is able to type a search into a search engine. However, this technology doesn't stop the sender from asking the recipient the question. In addition, this technology does not consider a situation where a search engine cannot come up with an answer to a question.

Another current technology allows a user of a mobile data processing device to send an SMS text message with a question. This text message is then received at a central computer and sent out to one or more human researchers to compose an answer. An answer is sent back as another text message to the mobile data processing device. The question is not restricted to any category of question and the question is sent using a premium rate text messaging service. Because a premium rate text messaging service is used, this simplifies the task of deploying a working system because it greatly reduces the complexity of the technical infrastructure required. In particular, the customer databases and billing systems can be dispensed with.

Rather than a sender sending a recipient a question, the sender could send the question to this alternative technology using the premium rate text messaging service. However, this technology is expensive and requires users to know the system's contact information. It is more likely that sender will know the recipient's contact information.

In addition, many online self-help solutions exist that parse a customer support question through an established frequently asked questions (FAQ) format in order to reduce interactions with live support personnel. Illustrative embodiments differ from these current technologies by, for example: 1) being implemented natively within traditional communications streams and not in a form-based solution that is intended to accept questions and produce answers; 2) taking into account multiple data sources to find answers to questions; and 3) generating a confidence level, which may take into account communication histories between users, as to the percentage of relevance an answer is to a particular question.

Illustrative embodiments stop a first user from sending an electronic message to a second user when illustrative embodiments determine that the question the first user is asking in the electronic message can be answered by performing a search, either in the public realm or in private archives and user communication histories. The stop may just be an alert to a possible answer and a confirmation prompt to know whether illustrative embodiments are to continue with transmitting the electronic message or not. As a result, illustrative embodiments may reduce labor costs due to workplace interruptions for common or easily answered questions from coworkers. In addition, illustrative embodiments may utilize cognitive question answering computer systems as a potential source of information for automatic question responses. Further, illustrative embodiments may be utilized by social networking applications and mobile text messaging services.

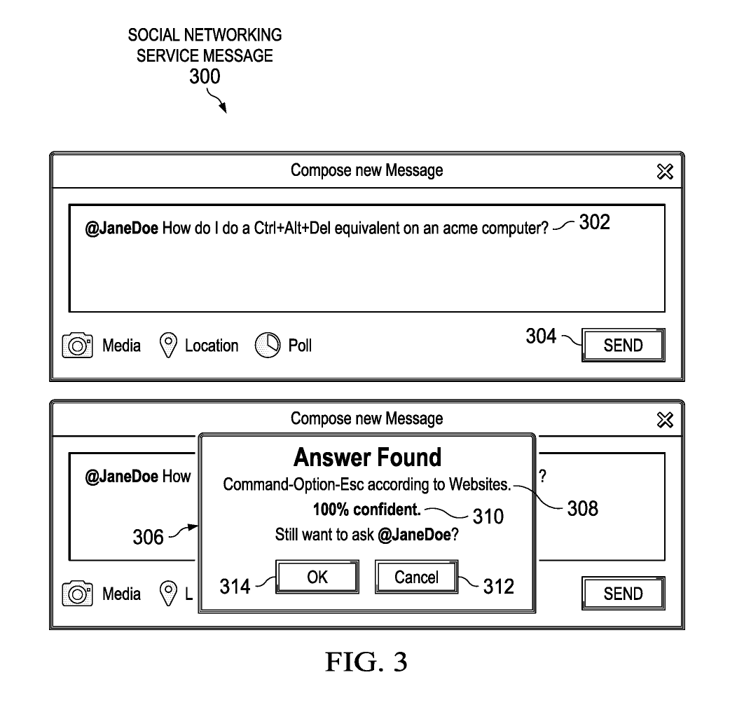

With reference now to FIG. 3, a diagram illustrating an example of a social networking service message is depicted in accordance with an illustrative embodiment. Social networking service message 300 may be, for example, message 222 in FIG. 2. Social networking service message 300 includes question 302. Question 302 may be, for example, question 232 in FIG. 2. In this example, question 302 is “How do I do a Ctrl+Alt+Del equivalent on an acme computer?”

After composing social networking service message 300, a user sends social networking service message 300 to another user by activating send input button 304. After activation of send input button 304, a question interceptor, such as, for example, question interceptor 218 in FIG. 2, identifies question 302 in social networking service message 300. In response to identifying question 302 in social networking service message 300, the question interceptor searches a plurality of data sources for a set of one or more answers corresponding to question 302.

In response to finding an answer to question 302, the question interceptor displays popup notification 306, which includes answer 308 and confidence score 310, to the user. Answer 308 and confidence score 310 may be, for example, answer 224 and confidence score 234 in FIG. 2. In this example, answer 308 is “Command-Option-Esc according to Websites” and confidence score 310 is “100% confident.” Further, the question interceptor asks the user whether the user still wants to ask the target recipient and displays “Cancel” input button 312 and “OK” input button 314 in popup notification 306. Activation of cancel input button 312, cancels transmission of social networking service message 300 to the target recipient. Activation of okay input button 314, continues transmission of social networking service message 300 to the target question recipient.

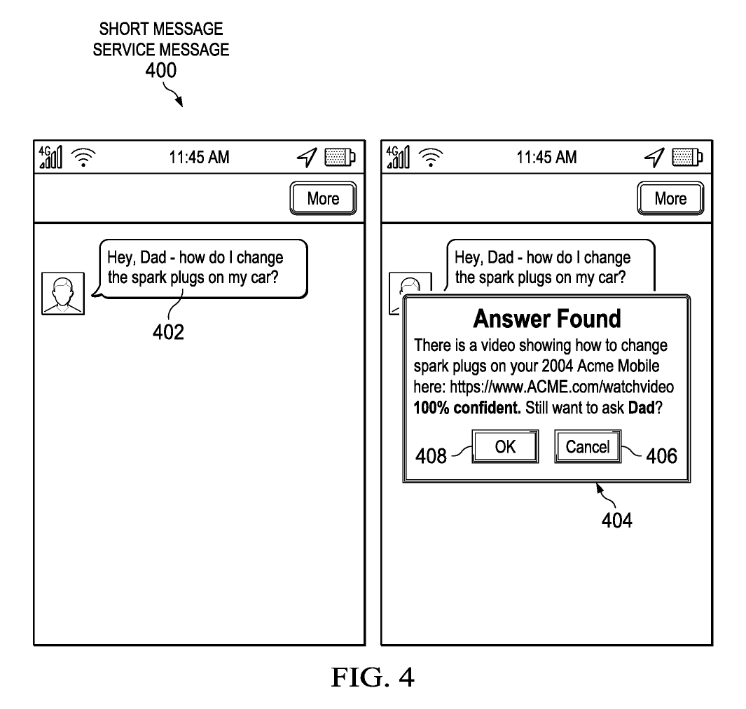

With reference now to FIG. 4, a diagram illustrating an example of a short message service message is depicted in accordance with an illustrative embodiment. Short message service message 400 may be, for example, message 222 in FIG. 2. Short message service message 400 includes question 402. Question 402 may be, for example, question 232 in FIG. 2. In this example, question 402 is “Hey, Dad—how do I change the spark plugs on my car?” It should be noted that question 402 is a generic question without including details such as the make, model, and year of the car. As a result, current technology will not know how to search for or find an appropriate answer to question 402.

After composing short message service message 400, a user activates a send input button, such as, for example, send input button 304 in FIG. 3, to send short message service message 400 to a target recipient. Then, a question interceptor, such as, for example, question interceptor 218 in FIG. 2, identifies question 402 in short message service message 400. In response to identifying question 402, the question interceptor searches a plurality of data sources for an answer to question 402. For example, the question interceptor may search a profile, such as user profile 220 in FIG. 2, corresponding to the user that may include information, such as the make, model, and year of the user's car or search a question history, such as question history 228 in FIG. 2, of previous communications that may include the same type of information. After discovering this information, the question interceptor is now able to intelligently search for the appropriate answer to question 402.

Subsequent to finding an answer to question 402, the question interceptor displays popup notification 404, which includes the answer and a confidence score to the user. In this example, the answer is “There is a video showing how to change spark plugs on your 2004 acme mobile here: https://www.acme.com/watchvideo?” and the confidence score is “100% confident.” Further, the question interceptor asks “Still want to ask Dad?” and displays “Cancel” input button 406 and “OK” input button 408 in popup notification 404. Activation of cancel input button 406, cancels transmission of short message service message 400 to the target recipient. Activation of okay input button 408, continues transmission of short message service message 400 to the target recipient.

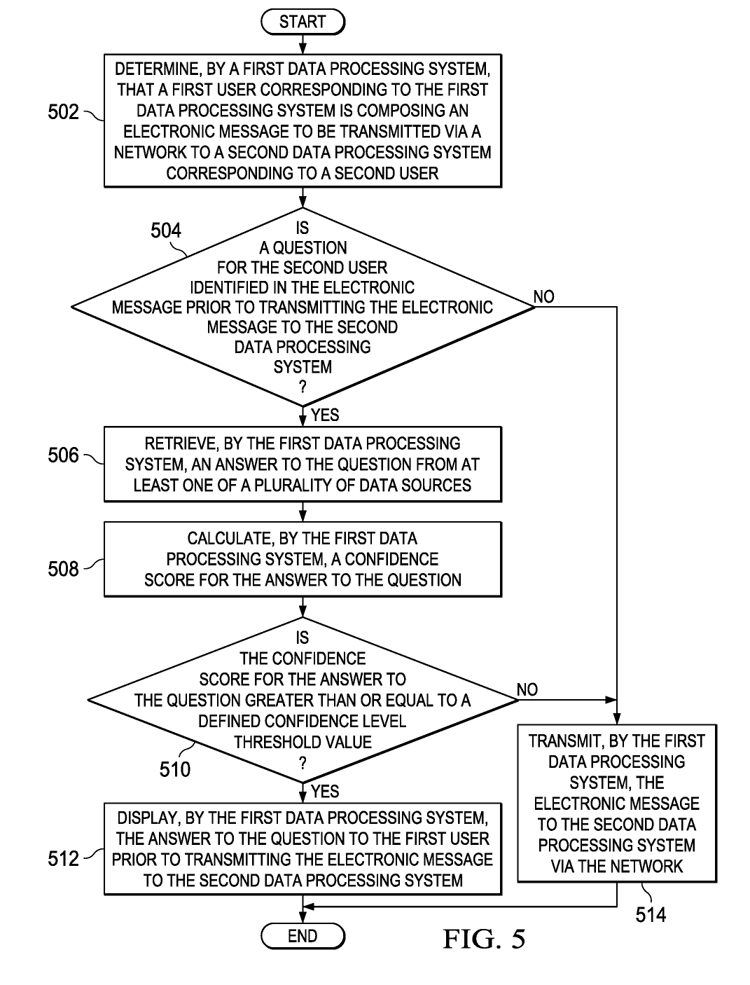

With reference now to FIG. 5, a flowchart illustrating a process for displaying an answer to a question included in an electronic message prior to transmitting the electronic message is shown in accordance with an illustrative embodiment. The process shown in FIG. 5 may be implemented in a data processing system, such as, for example, client 110 in FIG. 1 and data processing system 200 in FIG. 2.

The process begins when the first data processing determines that a first user corresponding to the first data processing system is composing an electronic message to be transmitted via a network to a second data processing system corresponding to a second user (step 502). The electronic message may be, for example, message 222 in FIG. 2. The network and second data processing system may be, for example, network 102 and client 112 in FIG. 1.

After determining that an electronic message was being composed in step 502, the first data processing system makes a determination as to whether a question for the second user is identified in the electronic message prior to transmitting the electronic message to the second data processing system (step 504). The question may be, for example, question 232 in FIG. 2. If the first data processing system determines that a question for the second user is identified in the electronic message prior to transmitting the electronic message to the second data processing system, yes output of step 504, then the first data processing system retrieves an answer to the question from at least one of a plurality of data sources (step 506). The answer may be, for example, answer 224 in FIG. 2.

In addition, the first data processing system calculates a confidence score for the answer to the question (step 508). The confidence score may be, for example, confidence score 234 in FIG. 2. Afterward, the first data processing system makes a determination as to whether the confidence score for the answer to the question is greater than or equal to a defined confidence level threshold value (step 510). The defined confidence level threshold value may be, for example, confidence level threshold value 226 in FIG. 2.

If the first data processing system determines that the confidence score for the answer to the question is greater than or equal to the defined confidence level threshold value, yes output of step 510, then the first data processing system displays the answer to the question to the first user prior to transmitting the electronic message to the second data processing system (step 512). Thereafter, the process terminates.

Returning again to step 504, if the first data processing system determines that a question for the second user is not identified in the electronic message prior to transmitting the electronic message to the second data processing system, no output of step 504, then the first data processing system transmits the electronic message to the second data processing system via the network (step 514). Thereafter, the process terminates.

Returning again to step 510, if the first data processing system determines that the confidence score for the answer to the question is less than the defined confidence level threshold value, no output of step 510, then the process proceeds to step 514 where the first data processing system transmits the electronic message.

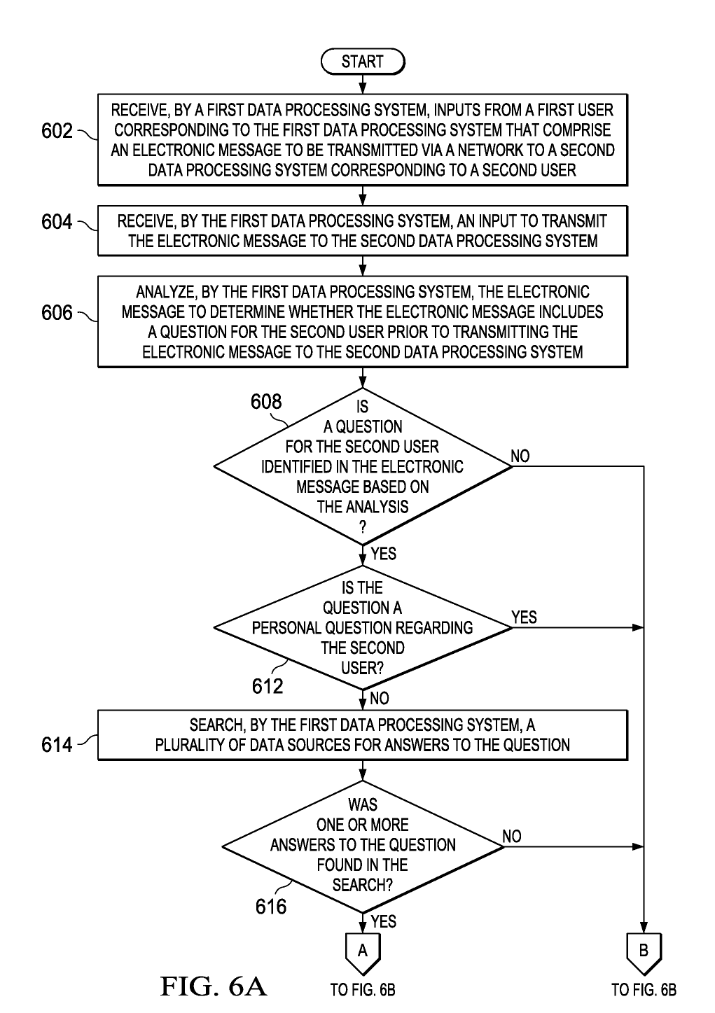

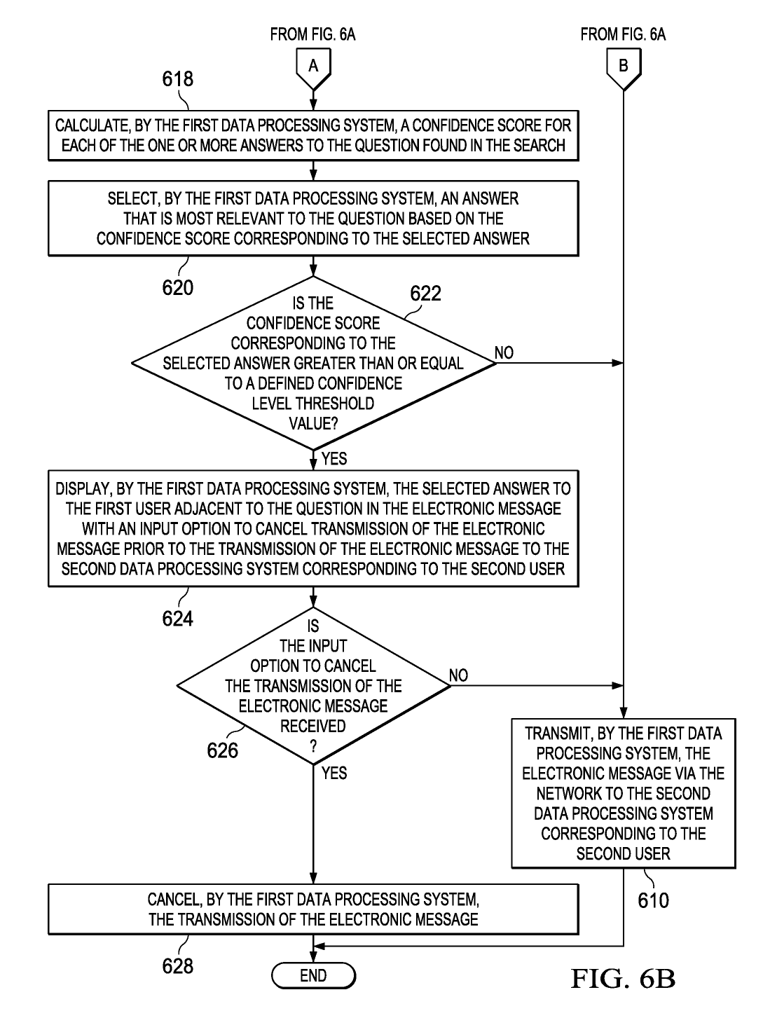

With reference now to FIGS. 6A-6B, a flowchart illustrating a process for intercepting a question included in an electronic message prior to transmitting the electronic message is shown in accordance with an illustrative embodiment. The process shown in FIGS. 6A-6B may be implemented in a data processing system, such as, for example, client 110 in FIG. 1 and data processing system 200 in FIG. 2.

The process begins when the first data processing system receives inputs from a first user corresponding to the first data processing system that comprise an electronic message to be transmitted via a network to a second data processing system corresponding to a second user (step 602). The electronic message may be, for example, message 222 in FIG. 2. The network and second data processing system may be, for example, network 102 and client 112 in FIG. 1.

Subsequently, the first data processing system receives an input to transmit the electronic message to the second data processing system (step 604). Afterward, the first data processing system analyzes the electronic message to determine whether the electronic message includes a question for the second user prior to transmitting the electronic message to the second data processing system (step 606). The first data processing system may analyze the electronic message by utilizing, for example, contextual analysis, natural language processing, parsing, and the like.

After analyzing the electronic message in step 606, the first data processing system makes a determination as to whether a question for the second user is identified in the electronic message based on the analysis (step 608). The question may be, for example, question 232 in FIG. 2. If the first data processing system determines that a question for the second user is not identified in the electronic message based on the analysis, no output of step 608, then the first data processing system transmits the electronic message via the network to the second data processing system corresponding to the second user (step 610). Thereafter, the process terminates.

If the first data processing system determines that a question for the second user is identified in the electronic message based on the analysis, yes output of step 608, then the first data processing system makes a determination as to whether the question is a personal question regarding the second user (step 612). The first data processing system may utilize, for example, machine learning to identify personal questions. A personal question may be, for example, “How are you?”, “How was your day?”, What are you doing for lunch today?”, “What are you wearing to the dinner party on Saturday?”, and the like.

If the first data processing system determines that the question is a personal question regarding the second user, yes output of step 612, then the process returns to step 610 where the first data processing system transmits the electronic message. If the first data processing system determines that the question is not a personal question regarding the second user, no output of step 612, then the first data processing system searches a plurality of data sources for answers to the question (step 614).

Subsequent to searching the plurality of data sources in step 614, the first data processing system makes a determination as to whether one or more answers to the question was found in the search (step 616). If the first data processing system determines that no answers to the question were found in the search, no output of step 616, then the process returns to step 610 where the first data processing system transmits the electronic message. If the first data processing system determines that one or more answers to the question was found in the search, yes output of step 616, then the first data processing system calculates a confidence score for each of the one or more answers to the question found in the search (step 618). The confidence score may be, for example, confidence score 234 in FIG. 2.

Further, the first data processing system selects an answer that is most relevant to the question based on the confidence score corresponding to the selected answer (step 620). Furthermore, the first data processing system makes a determination as to whether the confidence score corresponding to the selected answer is greater than or equal to a defined confidence level threshold value (step 622). The defined confidence level threshold value may be, for example, confidence level threshold value 226 in FIG. 2.

If the first data processing system determines that the confidence score corresponding to the selected answer is less than the defined confidence level threshold value, no output of step 622, then the process returns to step 610 where the first data processing system transmits the electronic message. If the first data processing system determines that the confidence score corresponding to the selected answer is greater than or equal to the defined confidence level threshold value, yes output of step 622, then the first data processing system displays the selected answer to the first user adjacent to the question in the electronic message with an input option to cancel transmission of the electronic message prior to the transmission of the electronic message to the second data processing system corresponding to the second user (step 624). The input option to cancel the transmission of the electronic message may be, for example, cancel input button 312 in FIG. 3 or cancel input button 406 in FIG. 4.

Moreover, the first data processing system makes a determination as to whether the input option to cancel the transmission of the electronic message is received (step 626). If the first data processing system determines that the input option to cancel the transmission of the electronic message is not received, no output of step 626, then the process returns to step 610 where the first data processing system transmits the electronic message. If the first data processing system determines that the input option to cancel the transmission of the electronic message is received, yes output of step 626, then the first data processing system cancels the transmission of the electronic message (step 628). Thereafter, the process terminates.

Thus, illustrative embodiments of the present invention provide a computer-implemented method, data processing system, and computer program product for intercepting questions included within electronic messages to be sent from a user of a sending data processing system device to another user on a receiving data processing system device prior to transmission of the electronic message from the sending data processing system device to the receiving data processing system device. Illustrative embodiments focus on the pre-emptive steps of identifying a question in an otherwise non-Q&A scenario and use commonly available information, such as, for example, general Q&A database type data, private communications histories between a particular pair of senders/recipients or related users, and social network data, to present a user with a potentially satisfactory answer with a confidence score prior to transmission of the question to its target recipient. As a result, illustrative embodiments may potentially protect a recipient and the recipient's data processing system from ever receiving the communication in the first place.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiment. The terminology used herein was chosen to best explain the principles of the embodiment, the practical application or technical improvement over technologies found in the marketplace, or to enable others of ordinary skill in the art to understand the embodiments disclosed here.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1. A computer-implemented method for question interception, the computer-implemented method comprising:
determining, by a data processing system, that a first user corresponding to the data processing system is composing an electronic message to be transmitted via a network to a second data processing system corresponding to a second user;
determining, by the data processing system, whether a question for the second user is identified in the electronic message prior to transmitting the electronic message to the second data processing system;
responsive to the data processing system determining that a question for the second user is identified in the electronic message prior to transmitting the electronic message to the second data processing system, retrieving, by the data processing system, an answer to the question from at least one of a plurality of data sources;
calculating, by the data processing system, a confidence score for the answer to the question;
determining, by the data processing system, whether the confidence score for the answer to the question is greater than or equal to a defined confidence level threshold value; and
responsive to the data processing system determining that the confidence score for the answer to the question is greater than or equal to the defined confidence level threshold value, displaying, by the data processing system, the answer to the question to the first user prior to transmitting the electronic message to the second data processing system.

2. The computer-implemented method of claim 1 further comprising:
responsive to the data processing system determining that the confidence score for the answer to the question is less than the defined confidence level threshold value, transmitting, by the data processing system, the electronic message to the second data processing system.

3. The computer-implemented method of claim 1 further comprising:
determining, by the data processing system, whether the question is a personal question regarding the second user;
responsive to the data processing system determining that the question is a personal question regarding the second user, transmitting, by the data processing system, the electronic message to the second data processing system; and
responsive to the data processing system determining that the question is not a personal question regarding the second user, searching, by the data processing system, the plurality of data sources for answers to the question.

4. The computer-implemented method of claim 1, wherein the data processing system displays the answer to the question to the first user in a pop up notification that includes the confidence score for the answer, a first input button for cancelling transmission of the electronic message to the second data processing system, and a second input button for continuing transmission of the electronic message to the second data processing system.

5. The computer-implemented method of claim 1, wherein the confidence score for the answer is based, at least in part, on one or more previous electronic messages between the first user and the second user.

6. The computer-implemented method of claim 1, wherein the plurality of data sources includes search engine results, social media discussions associated with the question, and historical electronic messages between the first user and the second user.

7. The computer-implemented method of claim 1, wherein the electronic message is one of a group consisting of an email, a short message service text message, a direct electronic message, a social media textual message, a social networking service message, and an instant text message.

8. The computer-implemented method of claim 1, wherein the confidence score is a percentage of relevance the answer is to the question.

9. The computer-implemented method of claim 1, wherein the data processing system is one of a group consisting of a desktop computer, a laptop computer, a handheld computer, a smart phone, a smart watch, a personal digital assistant, a gaming device, and a set-top box.

10. The computer-implemented method of claim 1, wherein the answer is a set of answers, and wherein the data processing system selects an answer that is most relevant to the question from the set of answers based on the confidence score corresponding to the selected answer.

11. A data processing system for question interception, the data processing system comprising:
a bus system;
a storage device connected to the bus system, wherein the storage device stores program instructions; and
a processor connected to the bus system, wherein the processor executes the program instructions to:
determine that a first user corresponding to the data processing system is composing an electronic message to be transmitted via a network to a second data processing system corresponding to a second user;
determine whether a question for the second user is identified in the electronic message prior to transmitting the electronic message to the second data processing system;
retrieve an answer to the question from at least one of a plurality of data sources in response to determining that a question for the second user is identified in the electronic message prior to transmitting the electronic message to the second data processing system;
calculate a confidence score for the answer to the question;
determine whether the confidence score for the answer to the question is greater than or equal to a defined confidence level threshold value; and
display the answer to the question to the first user prior to transmitting the electronic message to the second data processing system in response to determining that the confidence score for the answer to the question is greater than or equal to the defined confidence level threshold value.

12. The data processing system of claim 11, wherein the processor further executes the program instructions to:
transmit the electronic message to the second data processing system in response to determining that the confidence score for the answer to the question is less than the defined confidence level threshold value.

13. The data processing system of claim 11, wherein the processor further executes the program instructions to:
determine whether the question is a personal question regarding the second user;
transmit the electronic message to the second data processing system in response to determining that the question is a personal question regarding the second user; and
search the plurality of data sources for answers to the question in response to determining that the question is not a personal question regarding the second user.

14. A computer program product for question interception, the computer program product comprising a computer readable storage medium having program instructions embodied therewith, the program instructions executable by a data processing system to cause the data processing system to perform a method comprising:
determining, by the data processing system, that a first user corresponding to the data processing system is composing an electronic message to be transmitted via a network to a second data processing system corresponding to a second user;
determining, by the data processing system, whether a question for the second user is identified in the electronic message prior to transmitting the electronic message to the second data processing system;
responsive to the data processing system determining that a question for the second user is identified in the electronic message prior to transmitting the electronic message to the second data processing system, retrieving, by the data processing system, an answer to the question from at least one of a plurality of data sources;
calculating, by the data processing system, a confidence score for the answer to the question;
determining, by the data processing system, whether the confidence score for the answer to the question is greater than or equal to a defined confidence level threshold value; and
responsive to the data processing system determining that the confidence score for the answer to the question is greater than or equal to the defined confidence level threshold value, displaying, by the data processing system, the answer to the question to the first user prior to transmitting the electronic message to the second data processing system.

15. The computer program product of claim 14 further comprising:
responsive to the data processing system determining that the confidence score for the answer to the question is less than the defined confidence level threshold value, transmitting, by the data processing system, the electronic message to the second data processing system.

16. The computer program product of claim 14 further comprising:
determining, by the data processing system, whether the question is a personal question regarding the second user;
responsive to the data processing system determining that the question is a personal question regarding the second user, transmitting, by the data processing system, the electronic message to the second data processing system; and
responsive to the data processing system determining that the question is not a personal question regarding the second user, searching, by the data processing system, the plurality of data sources for answers to the question.

17. The computer program product of claim 14, wherein the first data processing system displays the answer to the question to the first user in a pop up notification that includes the confidence score for the answer, a first input button for cancelling transmission of the electronic message to the second data processing system, and a second input button for continuing transmission of the electronic message to the second data processing system.

18. The computer program product of claim 14, wherein the confidence score for the answer is based, at least in part, on one or more previous electronic messages between the first user and the second user.

19. The computer program product of claim 14, wherein the plurality of data sources includes search engine results, social media discussions associated with the question, and historical electronic messages between the first user and the second user.

20. The computer program product of claim 14, wherein the electronic message is one of a group consisting of an email, a short message service text message, a direct electronic message, a social media textual message, a social networking service message, and an instant text message.
